(19) United States
(12) Patent Application Publication
(10) Pub. No.: US 2008/0294468 A1
(43) Pub. Date: Nov. 27, 2008

(54) PROCESS FOR AUTOMATING AND SIMPLIFYING COMMERCIAL INSURANCE TRANSACTIONS

(75) Inventor: Frederick M. Toland, JR., Santa Monica, CA (US)

Correspondence Address: KELLY LOWRY & KELLEY, LLP, 6320 CANOGA AVENUE, SUITE 1650, WOODLAND HILLS, CA, 91367, US

(73) Assignee: J. Key Corporation, Reno, NV (US)

(21) Appl. No.: 12/123,805

(22) Filed: May 20, 2008

Related U.S. Application Data
(60) Provisional application No. 60/939,166, filed on May 21, 2007.

(51) Int. Cl. G06Q 40/00

(52) U.S. Cl. 705/4

(57) ABSTRACT

The present invention relates to a process for automating and simplifying commercial insurance transactions, particularly at the broker level. Insurance transactions between brokers and insurance companies are automated and simplified through software processes. This is done by maintaining electronic databases of information on insured, insurance companies, and brokers. Brokers are able to view records for their client insureds as well as for the insurance companies from which they will receive quotes. Information is electronically populated into forms having a format which is transferable and readable by any of the parties involved.

### BACKGROUND OF THE INVENTION

The present invention generally relates to insurance transactions. More particularly, the present invention relates to a process for automating and simplifying commercial insurance transactions, particularly at the broker level.

The concept of utilizing insurance to insure a wide variety of property and occurrences is well known and has been used for quite some time. Individuals, as well as companies, are often insured for various purposes, and sometimes through different insurance companies. For example, an individual may utilize one insurance company for their automobiles, and yet another insurance company for their homeowner's insurance. In some circumstances, even yet another insurance company may be used specifically for earthquake or flood insurance. Of course, companies need various insurance policies for the many facets and aspects of their operations.

It is not uncommon for individuals and businesses alike to approach an insurance broker so that the broker can fulfill all of their insurance needs. The broker, with the individual or company, determines the types of insurance that are desired or necessary, and the broker contacts various insurance companies seeking cost quotes. Currently, this is a time consuming and cumbersome task. Oftentimes, the insurance broker will need to fill out a variety of forms with the same information in order to obtain cost quotes and approvals from a number of insurance companies. Some insurance companies may require additional information about the individual or business to be insured than others. The individual or business may also want to know information about the insurance company so as to weigh the relative cost to the services and reputation of the insurance company. The exchange of information between the person or business to be insured, the broker, and the insurance companies is not currently automated.

Accordingly, there is a continuing need for an automated system of facilitating the exchange of information, completion of forms and the like between individuals and businesses to be insured, brokers, and insurance companies. The present invention fulfills these needs, and provides other related advantages.

### SUMMARY OF THE INVENTION

The present invention is directed to a process for automating and simplifying transactions between brokers and insurance companies, in particular electronic transactions. The inventive process begins with maintaining an electronic database of information on insureds, insurance companies and brokers. The information on insureds may include the identity of the insured, current coverage of the insured, requests submitted on behalf of the insured, coverage levels requested by the insured, dates of requests by the insured, insured's responses to questions, and the status of requests by the insured. Information on brokers may include account/login information and clients, i.e., insureds. Information on insurance companies may include types of coverages offered and available endorsements.

A first relationship may be established between information on one of the brokers and information on one or more of the insureds. Further, a second relationship may be established between information on one of the brokers and information on one or more of the insurance companies. A broker may electronically review information on the insureds including reviewing open accounts, inactive accounts and available quotes. Available quotes may include offers for coverage, denials of coverage, and bound policies with payment history. Inactive accounts may include the status of previous requests for quote.

A broker may populate a plurality of electronic forms with the information on one of said insureds from the electronic database. The broker may then electronically transfer the plurality of electronic forms simultaneously to one or more of the insurance companies as requests for quote. The plurality of electronic forms are electronically readable by one or more of the insurance companies. The step of electronically transferring may include generating the electronic forms for printing, storing in the electronic database or e-mailing to an insurance company.

The broker will then receive electronic quotes from said one or more of the insurance companies that received the requests for quote. The broker may then electronically forward these quotes to the insured. If an electronic quote amounts to a denial, the broker may automatically resubmit that request for quote immediately or at some later time.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flowchart illustrating a log-in authenticator function and broker menu of the process of the present invention;

FIG. 2 is a flowchart illustrating an open accounts option on the broker menu in the process of the present invention;

FIG. 3 is a flowchart illustrating an available quotes option on the broker menu in the process of the present invention;

FIG. 4 is a flowchart illustrating a form library option on the broker menu of the process of the present invention;

FIG. 5 is a flowchart illustrated a feature pages option on the broker menu of the process of the present invention;

FIG. 6 is a flowchart illustrating various information request options on the broker menu of the process of the present invention;

FIG. 7 is a flowchart illustrating an inactive accounts option on the broker menu of the process of the present invention;

FIG. 8 is a flowchart illustrating an application link option under inactive accounts in the process of the present invention;

FIG. 9 is a flowchart illustrating an accounting option on the broker menu of the process of the present invention;

FIG. 10 is a flowchart illustrating an application link option on active quotes of the process of the present invention;

FIG. 11 is a flowchart illustrating an application link option for bound quotes of the process of the present invention;

FIG. 12 is a flowchart illustrating a quick quote application option on the broker menu of the process of the present invention;

FIG. 13 is a flowchart illustrating a certificate request option on the broker menu of the process of the present invention;

FIG. 14 is a flowchart illustrating an article library option on the broker menu of the process of the present invention;

FIG. 15 is a flowchart illustrating a glossary option on the broker menu of the process of the present invention;

FIG. 16 is a flowchart illustrating a spreadsheet comparison option on the broker menu of the process of the present invention;

FIG. 17 is a flowchart illustrating a new products option on the broker menu of the process of the present invention;

FIG. 18 is a flowchart illustrating a web-cast option on the broker menu of the process of the present invention;

FIG. 19 is a flowchart illustrating an events option on the broker menu of the process of the present invention;

FIG. 20 is a flowchart illustrating administrator log-in and administrator functions of the process of the present invention;

FIG. 21 is a flowchart illustrating a broker accounts option on the internal administrator menu of the process of the present invention;

FIG. 22 is a flowchart illustrating an open accounts option on an administrator broker summary of the process of the present invention;

FIG. 23 is a flowchart illustrating an application link for open quotes of the process of the present invention;

FIG. 24 is a flowchart illustrating submission of an application by an administrator of the process of the present invention;

FIG. 25 is a flowchart illustrating an application link for active quotes of the process of the present invention;

FIG. 26 is a flowchart illustrating an application link for viewing or binding active quotes of the process of the present invention;

FIG. 27 is a flowchart illustrating an application link for inquiries of inactive accounts by an administrator of the process of the present invention;

FIG. 28 is a flowchart illustrating an application link for insurance company maintenance of bound quotes of the process of the present invention;

FIG. 29 is a flowchart illustrating user maintenance of user and broker lists of the process of the present invention; and

FIG. 30 is a flowchart illustrating digital asset management of the process of the present invention.

### DETAILED DESCRIPTION OF THE INVENTION

As shown in the accompanying drawings, for purposes of illustration, the present invention resides in a process for automating and simplifying insurance transactions. As will be more fully discussed herein, the application of the present invention enables a broker to obtain information about a person or business to be insured, and this information can be electronically extracted or populated into a variety of application forms to be quickly and easily sent to various insurance companies electronically from which cost quotes and approvals are sought. Likewise, the broker can have easy access to a variety of forms and information about the various insurance companies. Application forms, cost quote forms and the like can be generated in an automated fashion and sent to the various insurance companies. Libraries and databases of information and forms are available to the broker, and others in the system. The system is particularly designed to be implemented as a series of software modules.

In a particularly preferred embodiment, the system's structure is functionally based, that is functions used when completing related tasks will be grouped together. For example, main menu components for broker use will be grouped together, but will not be grouped with main menu components for administrator use. This is anticipated to allow for more finely tuned access permissions, significantly reducing the risk of unauthorized access. The application will preferably use internal authorization for access to all broker and administrative functions. A user is authenticated once upon entering the application, and thereafter application components will check for user authorization to access particular components (menus, forms, documents) as they are requested by the user.

The system is structured into three modules, namely, insurance automation application (including shared components, style sheet library and script libraries); broker (broker functionality such as requesting submissions, status lists, question responses, etc.) and administrator (user management, internal application/process, and administration).

The process of the present invention includes a Main Application Frameset, which displays the login, navigation and application components. In the preferred embodiment the Main Application Frameset includes a navigation bar and a central display frame. Clicking on or activating a link in the navigation bar calls HTML code, scripts, or similar functionality to appear on the central display frame. A broker application menu (100) provides broker users access to broker application functions, such as account status buttons, research tool buttons, and administrative task buttons. In the preferred embodiment, each of these menu options will be listed in the navigation bar and clicking on any of the menu options will cause the appropriate tab set to be displayed in the central display frame. If a broker has any past-due conditions on accounts, the system preferably defaults to the administrative tasks tab set upon login with the accounting tab selected and the list of bound quotes displayed. Only appropriately logged in broker users can see and utilize these links.

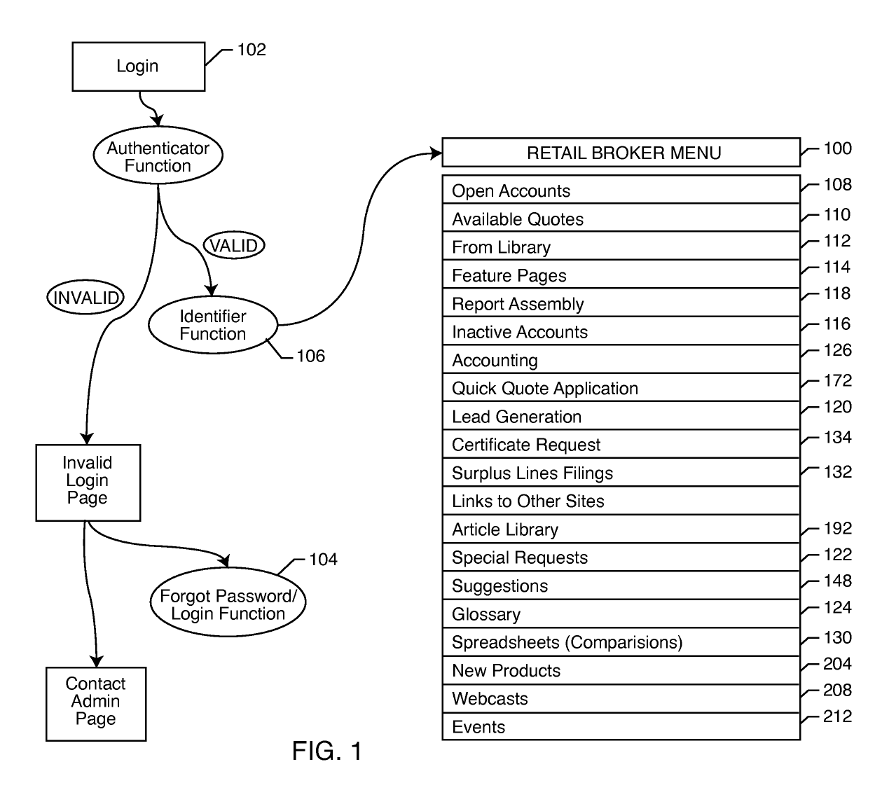

As illustrated in FIG. 1, a log-in function is used to accept user credentials and authentication. This may comprise user I.D. and password boxes to be completed by the user. An authenticator function or code (102) checks the user's credentials and allows access to appropriately authenticated users. That is, the user's identification password is checked against user identifications and passwords stored in a user's table, or other database. The authenticator function will also provide specific access and visual buttons and the like depending upon whether the user is a broker user only, a broker administrator, an internal user only, or an administrator. For example, logging in as a valid broker user displays the broker application start page. However, logging in as a valid internal administrator displays much more, including the user administration menu buttons. Logging with any invalid combination of user identification and/or password causes an error to be displayed. As shown in FIG. 1, the present invention contemplates a forgotten password/logged in function (104) wherein e-mail credentials to valid users who have forgotten either their logged in identification or password provides the same to a valid e-mail address. An identification function (106) is used to uniquely identify the logged in user throughout the system, such as when the user attempts to open each form. The user identification is checked against the database for validity to ensure that the user has access to the forms requested. If not, an error is displayed or access is simply not granted.

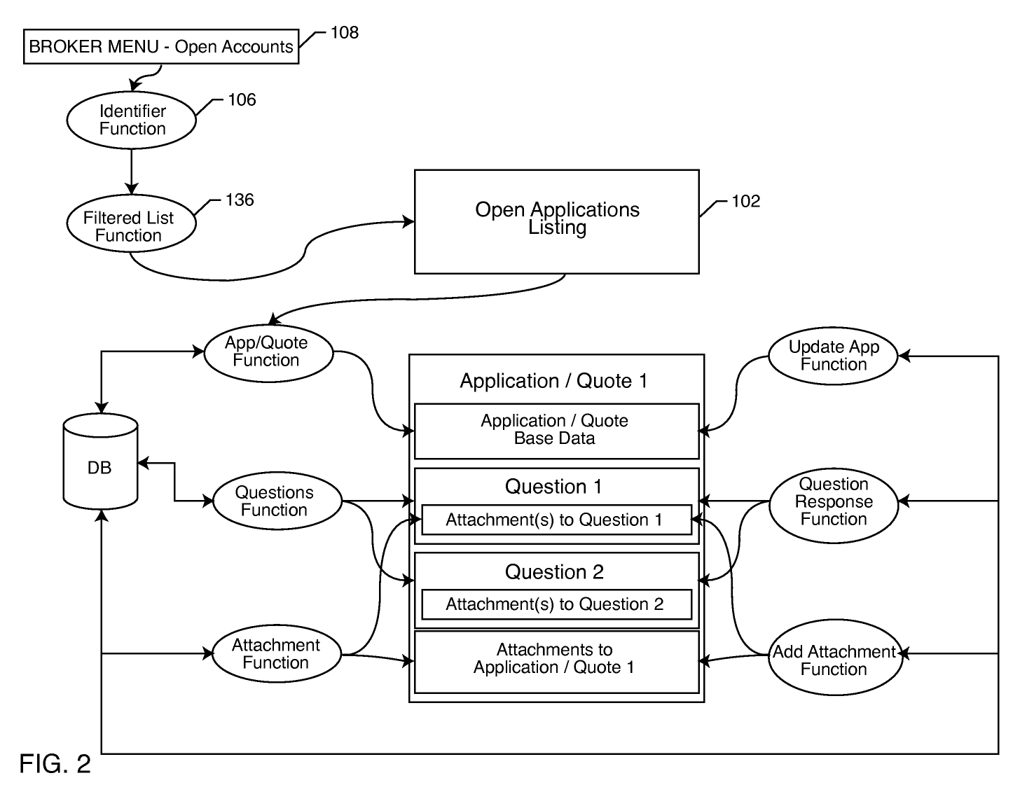

FIG. 1 illustrates the retail broker menu (100) with the various functions which are available to the user. Such user functions are illustrated in more detail in FIGS. 2-30, and described more fully herein.

Account status tabs allow broker users to navigate between account status forms. Such status forms or tabs include open accounts tab (108), available quotes tab (110), form library tab (112), feature pages tab (114), and inactive accounts (116). Clicking on any of these tabs causes the central frame display to navigate to the appropriate page. A research tools tab structure is also provided, allowing broker users to access research tool functions. These include a report assembly tab (118), a lead generation tab (120), a special request tab (122), and a glossary tab (124).

Administrative task tabs may also be provided which allow broker users to access broker administrative forms, if the proper user I.D. and password is matched. These may include an accounting tab (126) and user administration tab (128), as well as a spreadsheet tab (130), a surplus lines tab (132), and a certificates tab (134).

An open accounts grid is also provided which displays requests for quotation status and information. The grid typically displays the following columns: named insured, coverage, coverage level requested, request date, status, and edit indicator. The grid displays three sections, that is, requests pending questions/responses, insurance company requests/questions, and requests submitted.

The system will preferably have an electronic link for each application that the retail insurance brokers can send to their clients for completion. Preferably, the application will have the capability to recognize which Agency Management Software (AMS) product the retail insurance broker is using at any moment in time, such that the data can be transferred into the insurance broker's system, without any work being performed by them. Additionally, the system of the present invention will have the ability to communicate with its own Agency Management Software, such as Jetfile™/Riskman™, so that the system does not require manual entry of the data either.

With reference now to FIG. 2, in the broker menu (100), an open accounts tab (108) is provided. The identifier function (106) identifies the logged in user for verification purposes. A filtered list function (136) retrieves applications or quotes by the user and displays such in an open accounts grid as described above. The open applications listing function (138) extracts stored information relating to open accounts from the database and formats the data for display. This function (138) returns only open account records which are assigned to the logged in broker. Data for individual applications or quotes, questions which need to be responded to, as well as responses and updates, are provided. Open questions which have not been responded to may be flagged so that the broker can obtain additional information and respond to them as necessary.

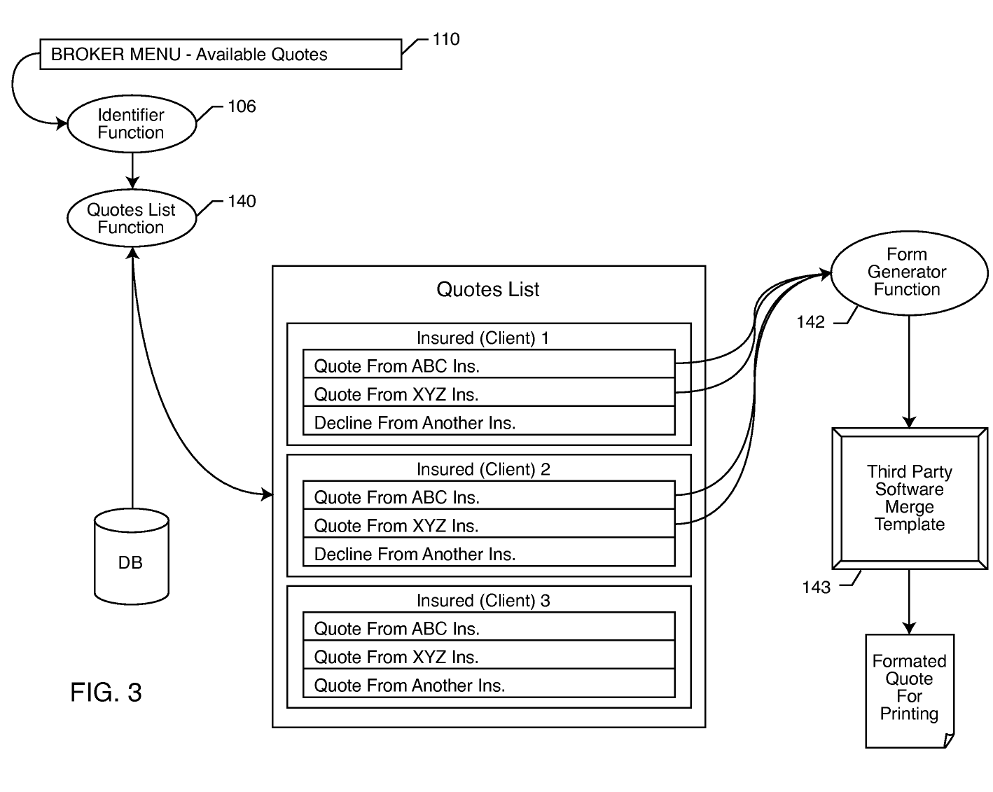

With reference now to FIG. 3, an available quotes menu (110) is also provided to the broker. Once again, the logged in user is identified and verified (106). A quotes list function (140) retrieves available quotes for the user. FIG. 3 illustrates exemplary quotes or application denials for preinsured clients. An available quotes grid and function extracts stored information relating to the available quotes from the database and formats the data for display in an open accounts grid.

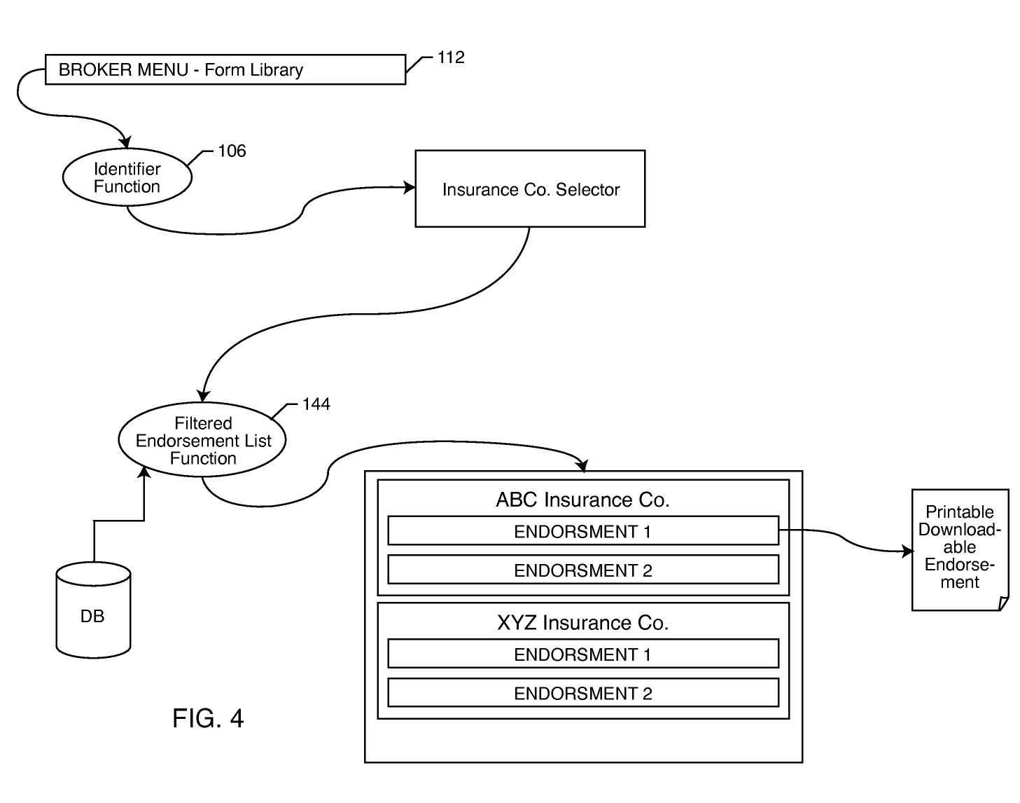

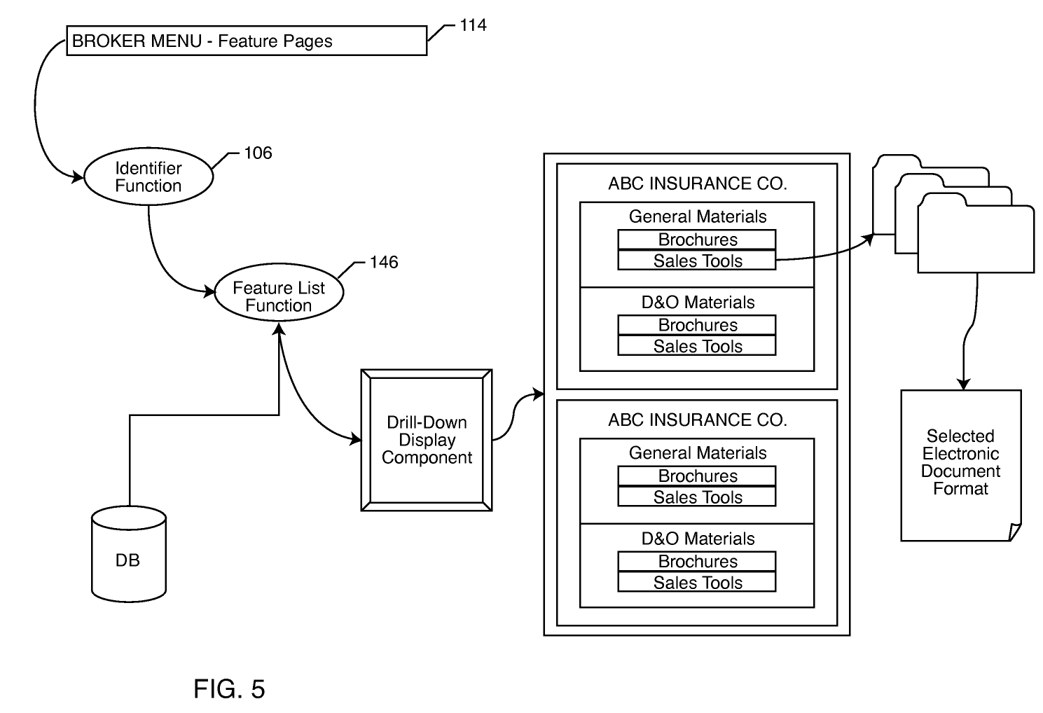

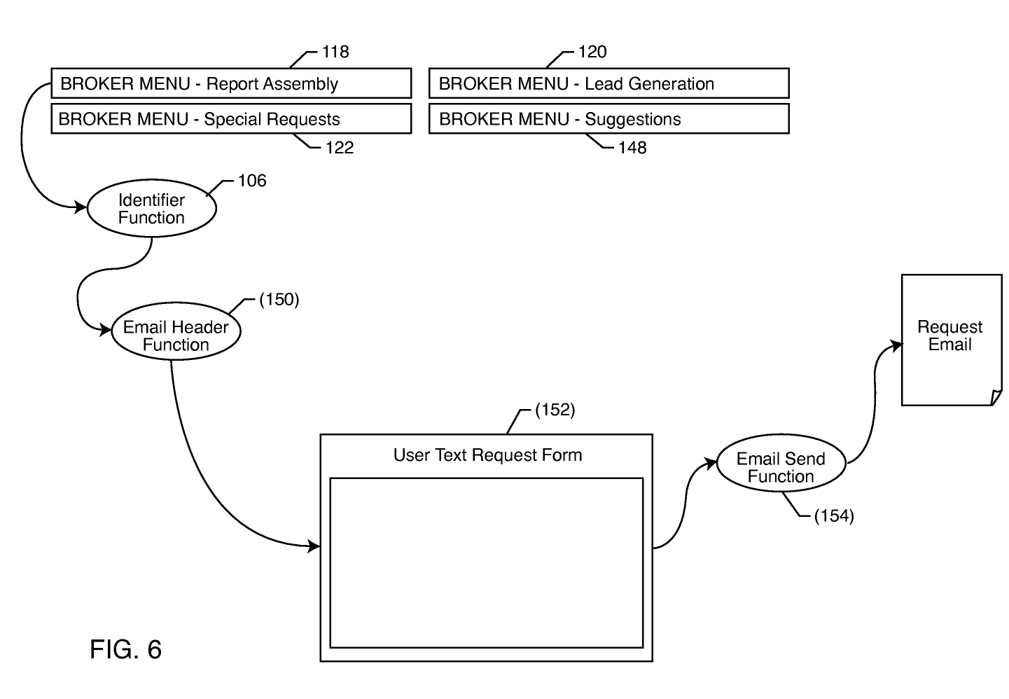

As illustrated in FIGS. 4-6, the available quotes may be selected, and a form generated (142) for either printing, storing as a file, or e-mailing. For example, these forms can be used to provide insurance quotes to the individual or company to be insured or generate reports (143). FIG. 4 illustrates the functionality of the form library tab (112). Again, the user is identified and verified (106). For each insurance company selected, a filtered endorsement list function (144) may retrieve appropriate endorsements from the database. Those endorsements may be in printable or downloadable form. FIG. 5 illustrates the feature pages tab (114) where again the identity of the logged in user is verified (106). A feature list function (146) retrieves appropriate features from the database for electronic download. FIG. 6 illustrates functionality for the report assembly tab (118), the lead generation tab (120), the special request tab (122) and a suggestions tab (148). Again, the user is subjected to the identifier function (106). An e-mail header function (150) generates an e-mail or other communication embodying a request for quote form (152). The request for quote form (152) is then processed by an e-mail send function (154) and sent to an insurance company.

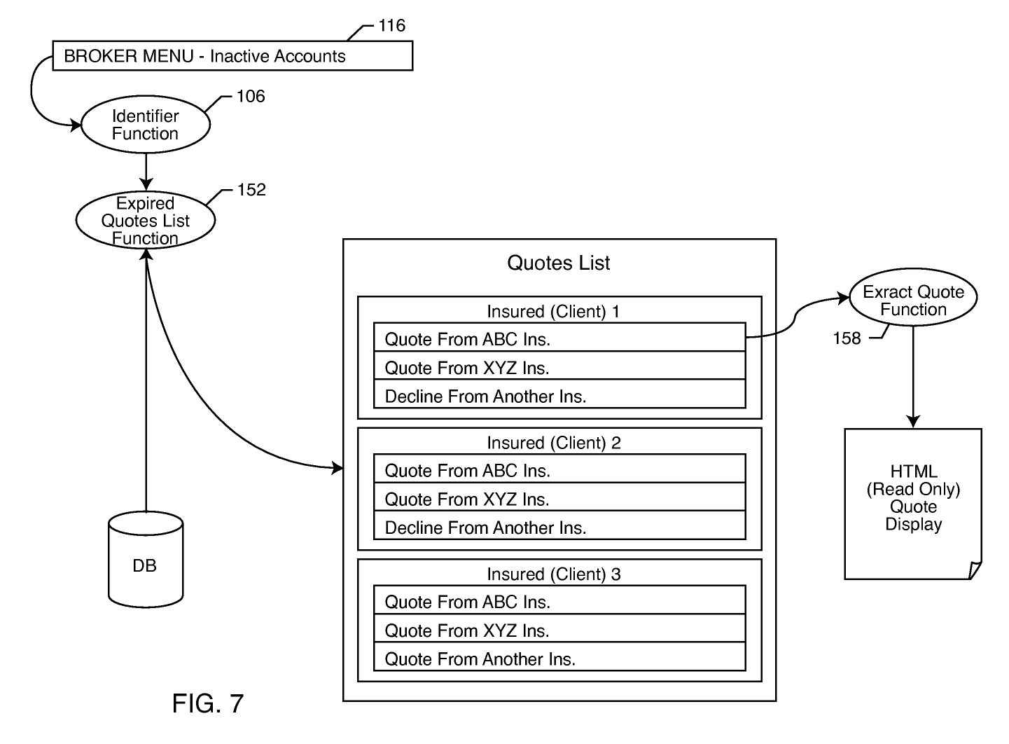

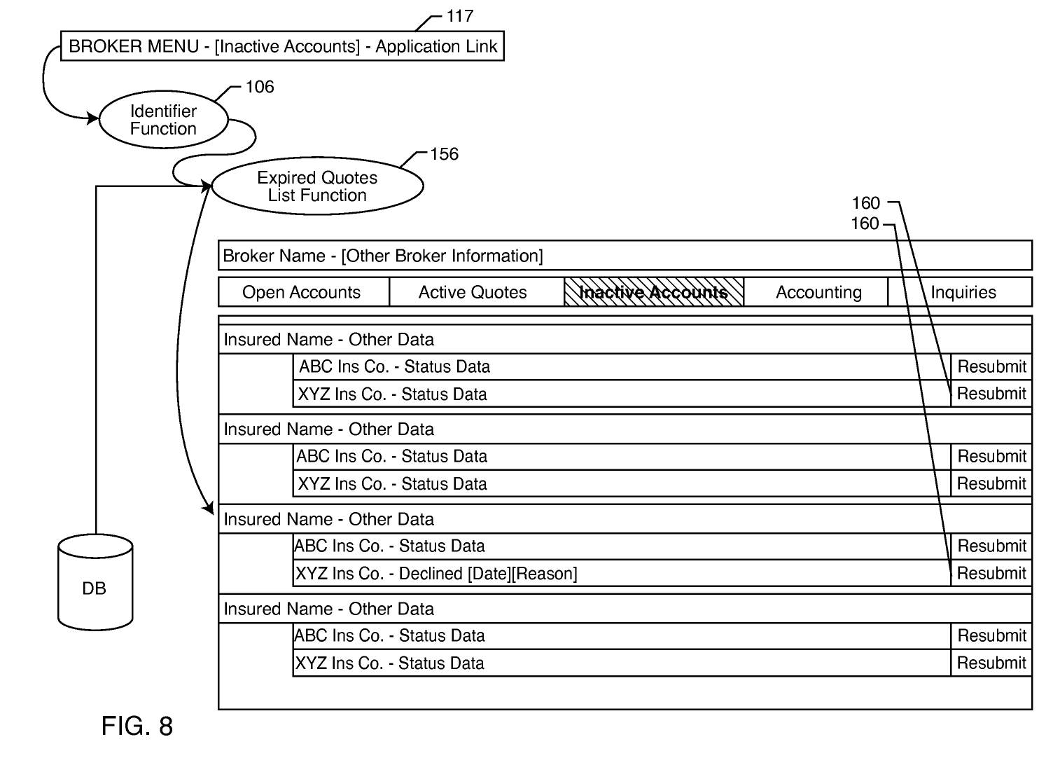

With reference now to FIGS. 7 and 8, an inactive accounts tab (116) may also be accessed, provided the logged in user is verified (106). When the “inactive accounts” tab (116) is selected in the broker detail application link (117), the expired quotes list function (156) extracts (158) expired quotes summary data from the database. Inactive account status and information is displayed in an open accounts grid style, and a link is displayed to allowed automatic resubmission of an expired quotation. This function allows the broker user to automatically resubmit (160) the data provided for any expired quotation. The resubmit function (160) automatically generates a renewal request based on the data submitted to the current bound policy. The specified quote record is copied to a new application record, which includes the currently-attached question responses and documents.

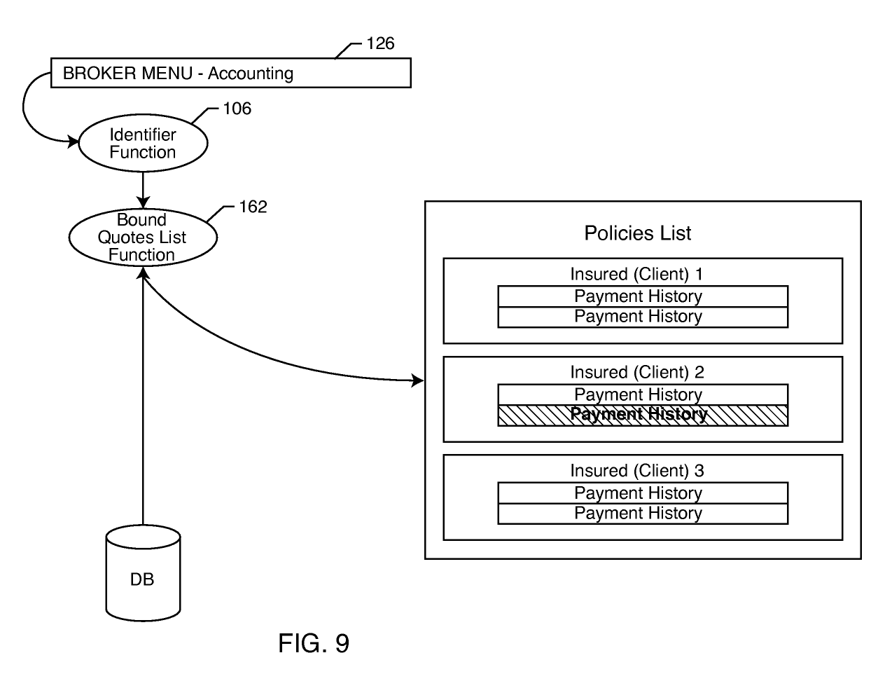

Using a bound quotes list function (162), bound policy status and information may also be displayed in an open accounts grid style. The broker identification is verified (106), and data including name, coverage, requested level, request date and status is returned. This function returns available quote records with the status of “bound” assigned to the logged-in broker. This function also returns a payment status of whether (paid or not paid), as illustrated in FIG. 9. The payment history for the various insureds and policies can also be accessed and displayed.

Authorized users are able to view and access an account/policy work form which presents account base data, questions and attachments to brokers. Moreover, this form presents questions to be added and status change functions to internal personnel. The “add” function is for inputting new requests for quotation by internal personnel. An “edit” mode can be used to modify the request or quote data. A read-only mode may also be used such that the information is only displayed and cannot be edited.

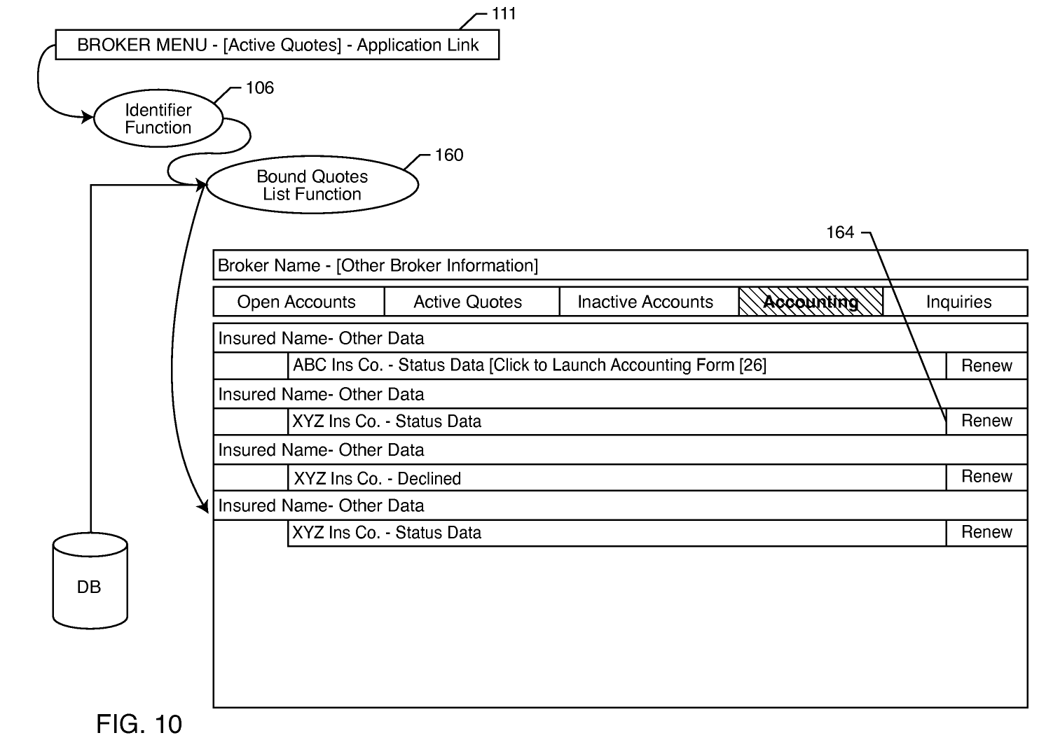

With reference to FIG. 10, when the accounting tab (110) is selected in the broker detail application link (111), the bound quotes list function (162) extracts bound quotes summary data from the database. A bind quote function and bind quote form can be used to present an interface to allow internal users or administrators to bind the selected quote and store quote bind data, including effective dates, premiums, insured and broker identities, and similar data in the database. This also enables changes to the quote status to be made as well as renewing (164) bound quotes.

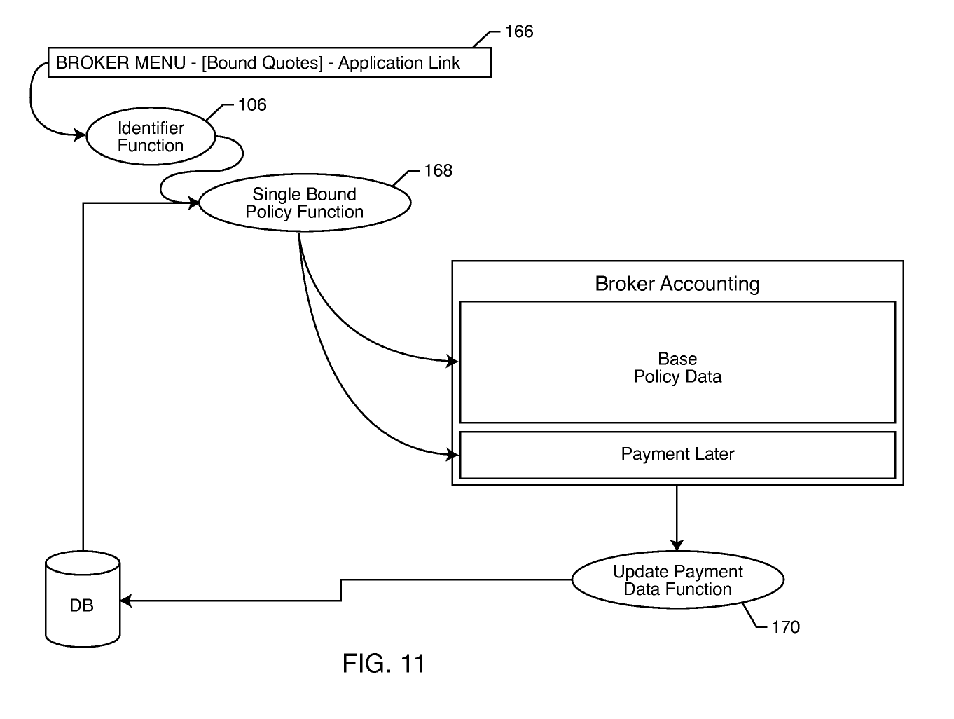

With reference to FIG. 11, under a bound quotes broker detail application link (166), a single bound policy function (168) extracts bound quote detail data from the database. An update payment data function (170) updates payment data for a single quote in the database. That is, the function (170) records payment of premium on a bound quote for past due payment tracking purposes. The payment data form presents an interface to allow internal users and administrators to record payment of premiums.

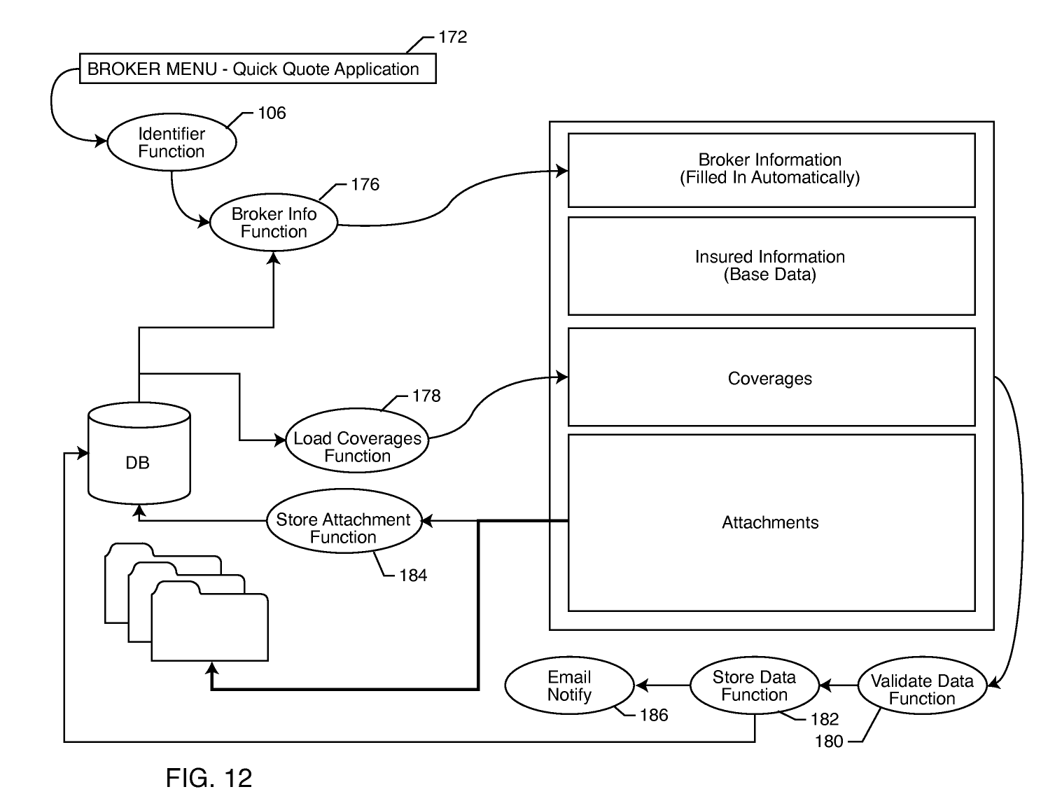

In FIG. 12, an application/quote function (172) extracts data for application/quotation from the database for presentation to the broker with the appropriate identification. Similarly, a questions function allows question data to be extracted from the database and formatted for presentation. In a particularly preferred embodiment, insurance companies will allow their quotation data to be transferred into the system in the same manner as application data from the Insured is transferred into the system. This would enable system representatives to review the quotation data and reassign it to its appropriate place in that particular retail broker's customized quotation template, without having to reenter the data.

An attached endorsement function of the present invention provides HTML, or the like, to accept data and store information for attached endorsements. The attachments function extracts attachments data and storage locations from databases and formats these for presentation. The add/update application function adds new application records using data input on the app/quote form, and updates data changes made on this form.

A question response function and form is made available to verified users which presents an interface to allow the user question response, and stores question responses in the database. It may be displayed as either an answer mode or as a view mode (read-only text boxes). Depending upon the mode, the user is either allowed to enter in responses to specific questions, or view previous data input representing responses to questions.

A form generator function (142) extracts data for a specific quote letter from the database for use by a reports generator (143). The reports generator (143) utilizes a template to generate a static PDF document such that data can be exported in that format so as to be viewable across different formats. An information request form is made available to allow the user to input text for special information requests, such as report assembly (118), lead generation (120), and other special requests (122). These requests are then stored in the appropriate form in the database.

With reference now to FIG. 12, in the broker menu, a quick application tab (172) is provided. Once the system verifies the logged in user (106), a broker information function (176) loads broker data from the database and formats it for presentation. This information is incorporated into a quick “form”, which typically displays as HTML to accept broker input for quick quotes for selected coverages. A load coverages function (178) loads coverages for selection from the database and into the form. A validate data function (180) checks the broker quick quote input for consistency and conformance to business rules quote. A store data function (182) then stores the broker quick quote input into the database. A store attachment function (184) may also store any attachments to the form in the database, as well. An e-mail notify function (186) generates a confirmation e-mail to the broker, and sends an alerting e-mail to internal personnel, as needed. That is, this function loads the application/quote record for use in an e-mail notification, and looks at the broker/user identification contact e-mail address from the user's table. The appropriate application/quote data is merged into the broker e-mail body, and the broker is sent the e-mail.

The present invention preferably includes an extract quote function, which extracts data for inactive quotes from the database. An inactive “presentation” displays the inactive quote data, typically as read-only text.

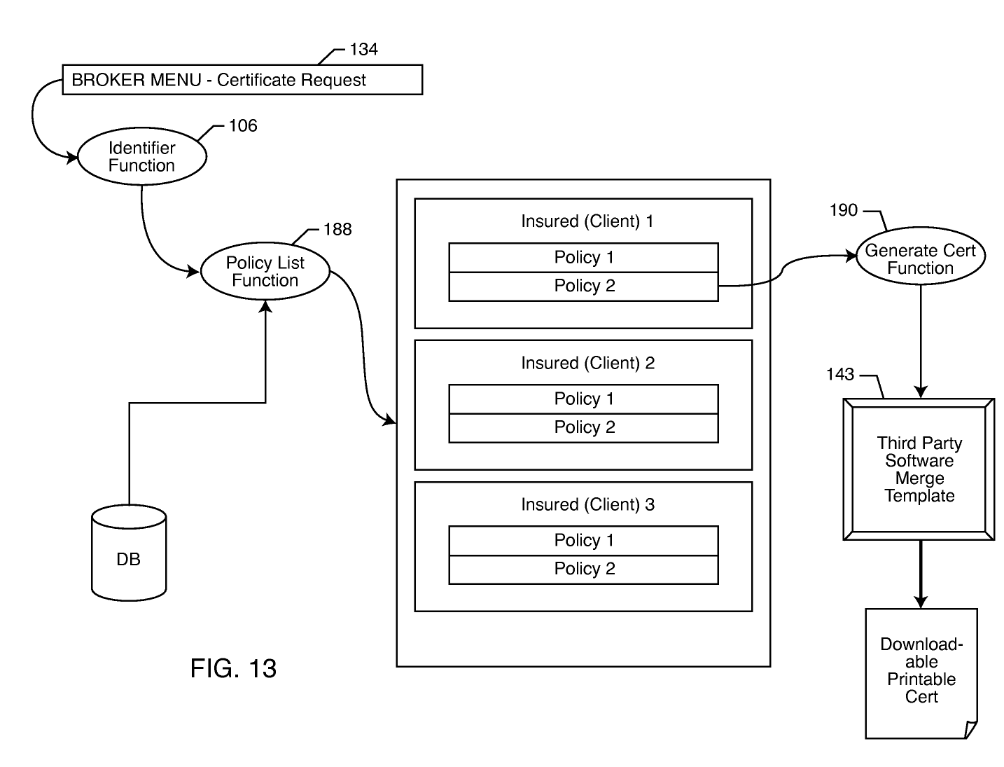

With reference now to FIG. 13, a certificate request procedure (134) under the broker menu is shown. After the user has been verified (106), a policy list function (188) loads policies in force, typically filtered by a broker. A generated certificate function (190) then creates a certificate in the appropriate format desired, which can then downloaded, printed, e-mailed, etc.

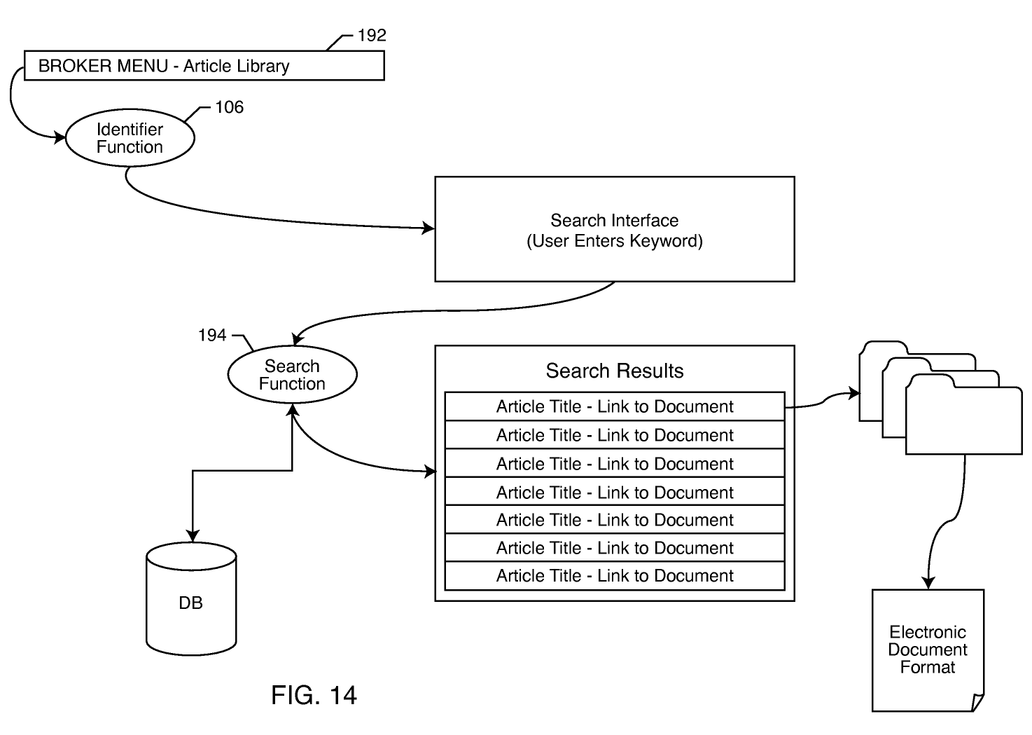

FIG. 14 illustrates an article library function (192) of the broker menu, wherein a search function (194) extracts links to documents which match the user's key word input. All of or a selected number of the documents can be stored electronically.

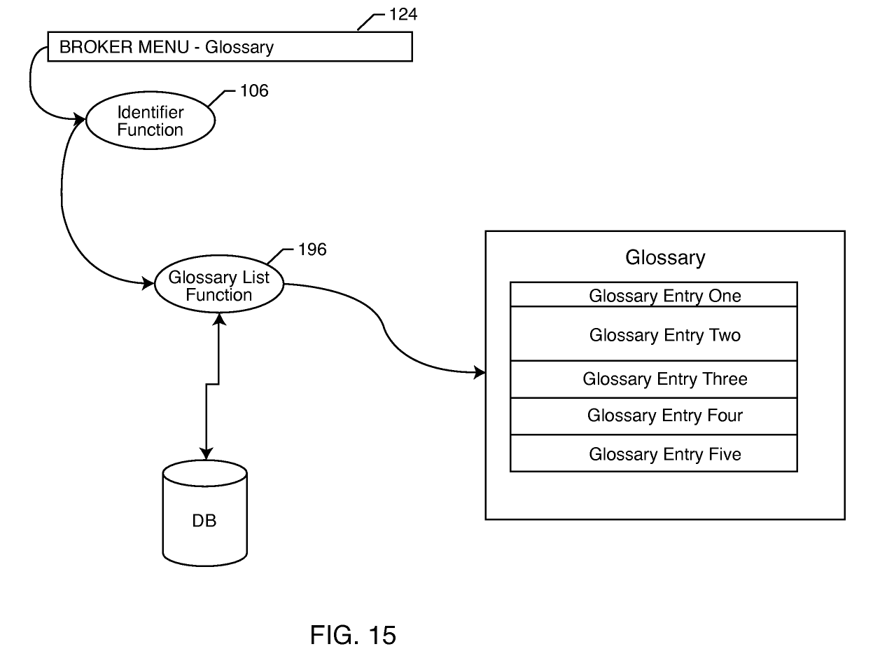

FIG. 15 illustrates a glossary (124) used in accordance with the present invention, wherein a glossary list function (196) extracts glossary listings from the database glossary table. This can be used by the broker, or for supplying information to the person to be insured for explanation purposes.

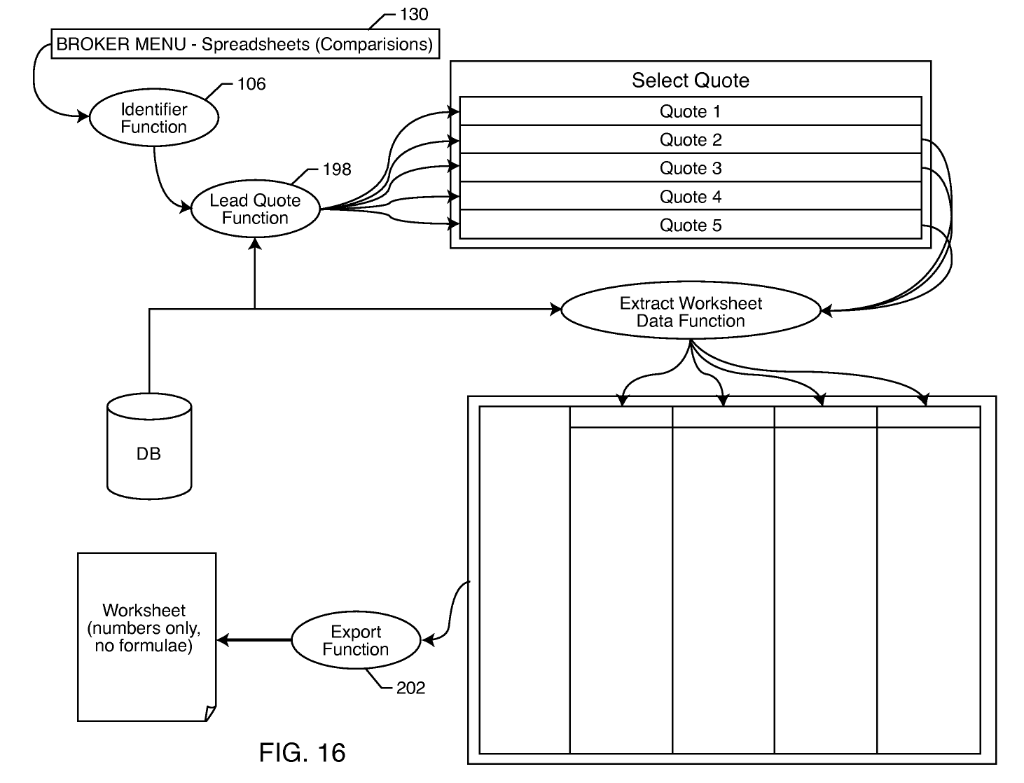

Under the broker menu, as shown in FIG. 16, spreadsheets (130), for comparison purposes, can be generated. A lead quote function (198) loads the broker's quotes, which may allow for selection of insurance company or insured. Predetermined datapoints are extracted from the database for each selected quote. These are displayed then side by side. For example, an extract work sheet data function (200) could perform this task for easy and quick review. An export function (202) then exports the information into a spread sheet on the broker's work station for further manipulation.

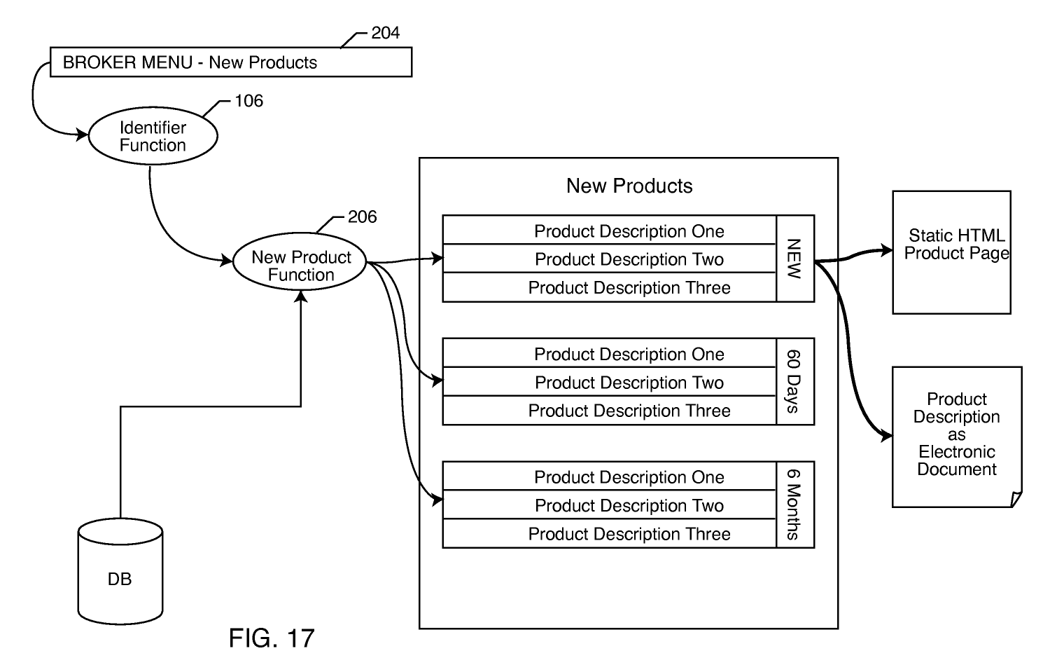

With reference to FIG. 17, a new products menu (204) is available to the broker menu wherein a new products function (206) extracts product descriptions from the database. These may be filtered by subscription level and release date. These can be viewed as a static page, or saved as an electronic document.

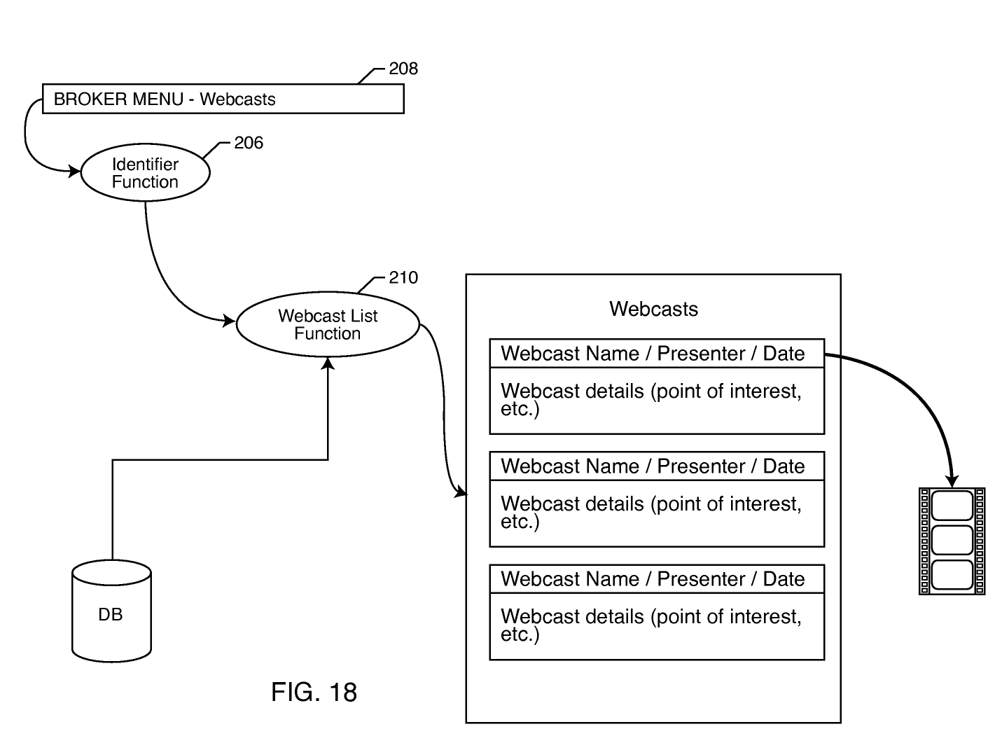

As shown in FIG. 18, in the webcast tab (208), a webcast function (210) extracts a list of current webcasts from the database, with name, presenter and detail data. Clicking a link on the list downloads the selected web cast to the user's work station for playback. This can be informational or educational in nature. This could be intended for the broker or the user insured. This enables insurance companies, or others affiliated with the system, to provide information as well as advertising and marketing.

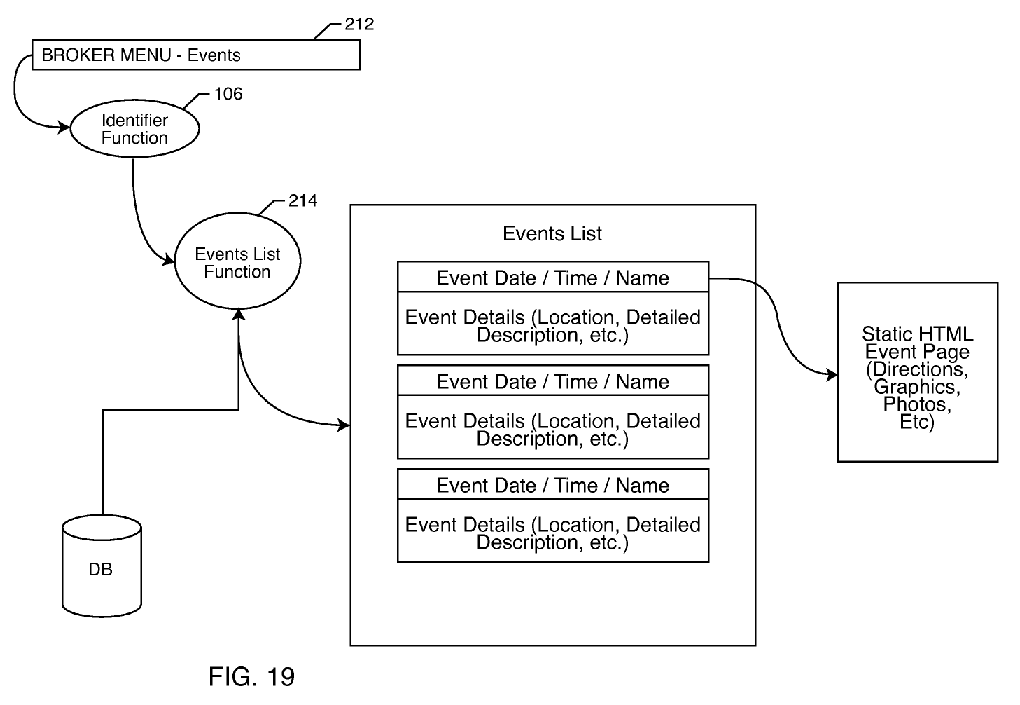

Similarly, FIG. 19 illustrates an event list function (214) in the events tab (212) of the present invention which extracts list data for future events from the database. The event name, date, time, and other details can be provided. Corrections, graphics, photos, etc., may either comprise the links or may be incorporated into the events list.

A broker user administrator, as indicated above, is given access to a greater number of features of the system of the present invention. For example, a broker user list displays a listing of broker users for broker user administration. The list may be edited to add or remove or update broker information. This can be done using a broker user administration form. The various broker users information or list may be viewed as a read-only file so as not to be edited, or an edit feature may be selected so as to update, add, delete, etc., broker user identifications, information, etc.

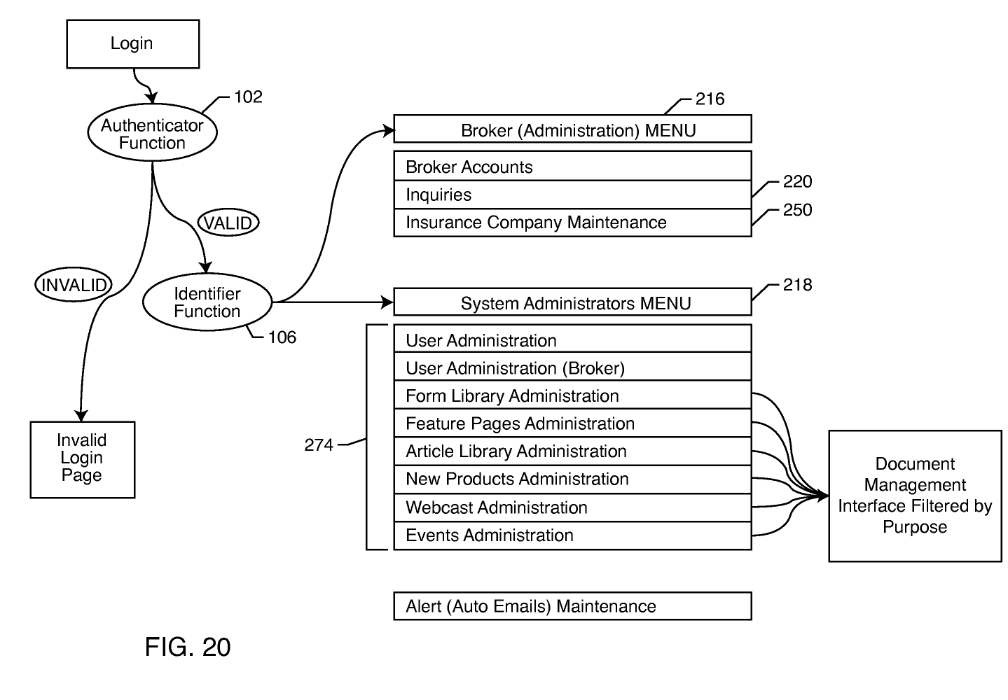

With reference now to FIG. 20, an administration menu (216) is different from the broker's menu (100), and is a top level menu having access to forms, menus, information, etc., that are not available to the broker users. The administrator's log in is authenticated (102) before being granted access to the menu of broker accounts, inquiries, and insurance company maintenance. A system administrator's menu (218) may also be provided, as shown in FIG. 20. Within this internal menu, broker accounts can be selected using a broker selection function.

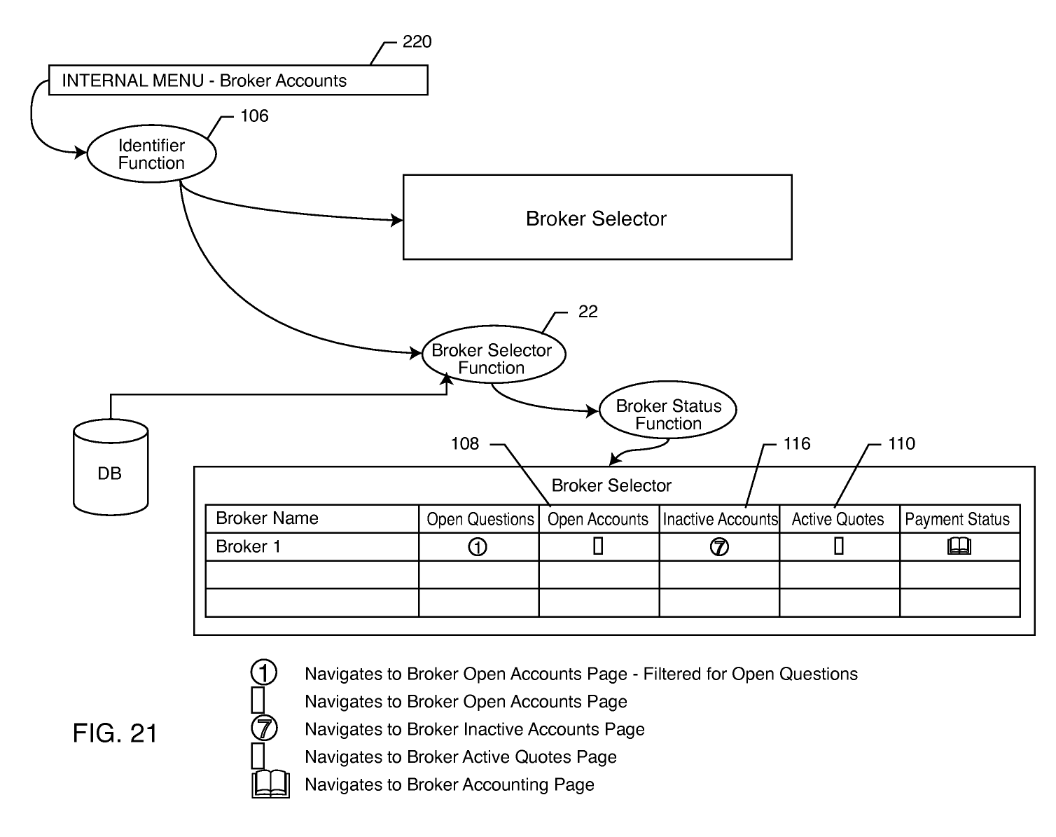

As shown in FIG. 21, under the Broker Accounts tab (220) in the Administration Menu (216) the broker selection function (222) extracts broker information from the database and formats this for presentation on the broker selection grid. The grid allows internal users or administrators to select brokers for whose accounts they are responsible. A broker dashboard tab structure allows internal users to navigate between account status forms, or back to the broker selection grid.

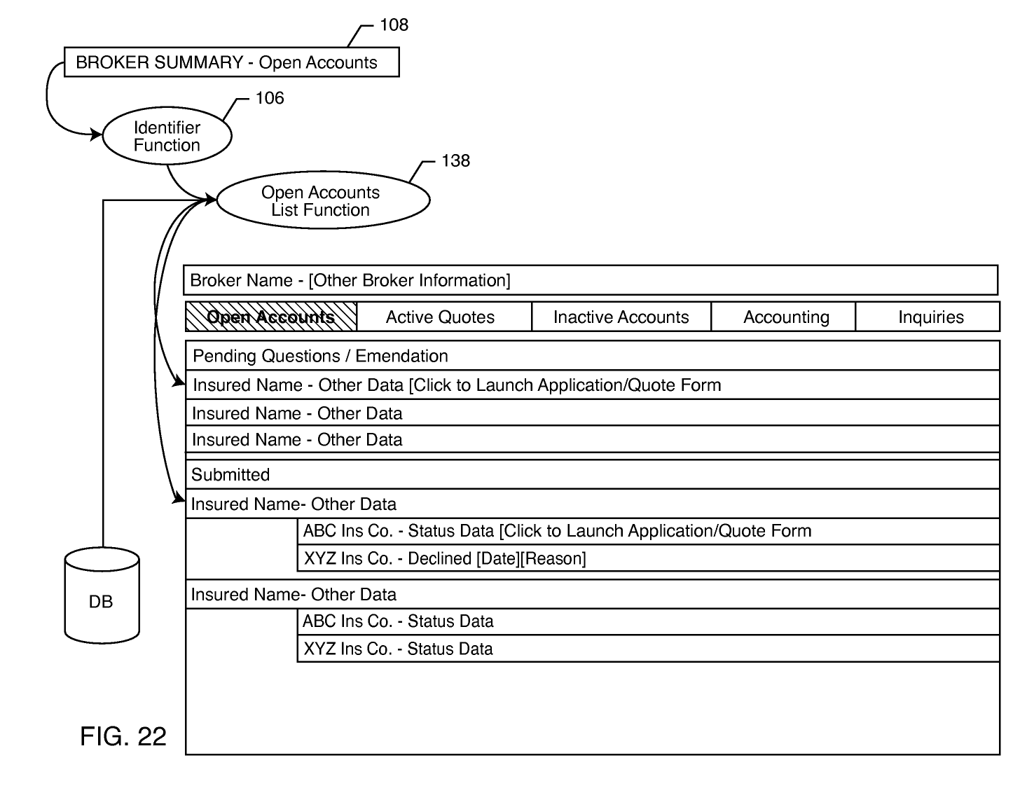

With reference now to FIG. 22, a broker summary open accounts function (138) extracts data on open accounts for a particular broker from the database. Such information under the broker name could include open accounts, active quotes, inactive accounts, accounting and inquiries.

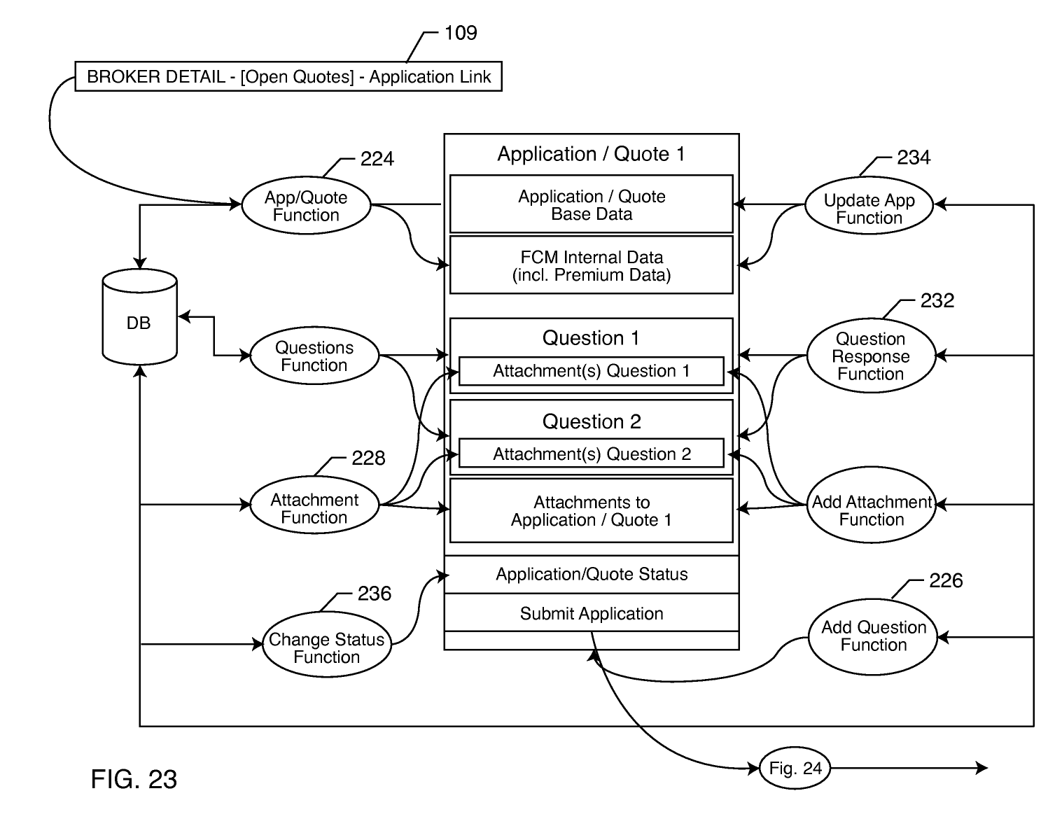

With reference now to FIG. 23, in the open quotes application link (109), an application/quote function (224) of the present invention enables broker details on open quotes to be presented. The application/quote function retrieves base data for individual applications or quotes. An add questions function (226) retrieves questions or data for each application or quote. An attachment function (228) retrieves attachment data for the application or quote, or question. A change status function (230) allows the administrator users to change the status of the application, such as providing a manual quote. For example, an add questions function (226) enables data to be entered on the add questions form. Similarly, an add attachment function (228) allows users to attach documents to questions, responses or the application/quote. A question response function (232) allows users to provide text responses to open questions and change question status to “closed”. Finally, an update application function (234) allows the user to update the application base data after changing it.

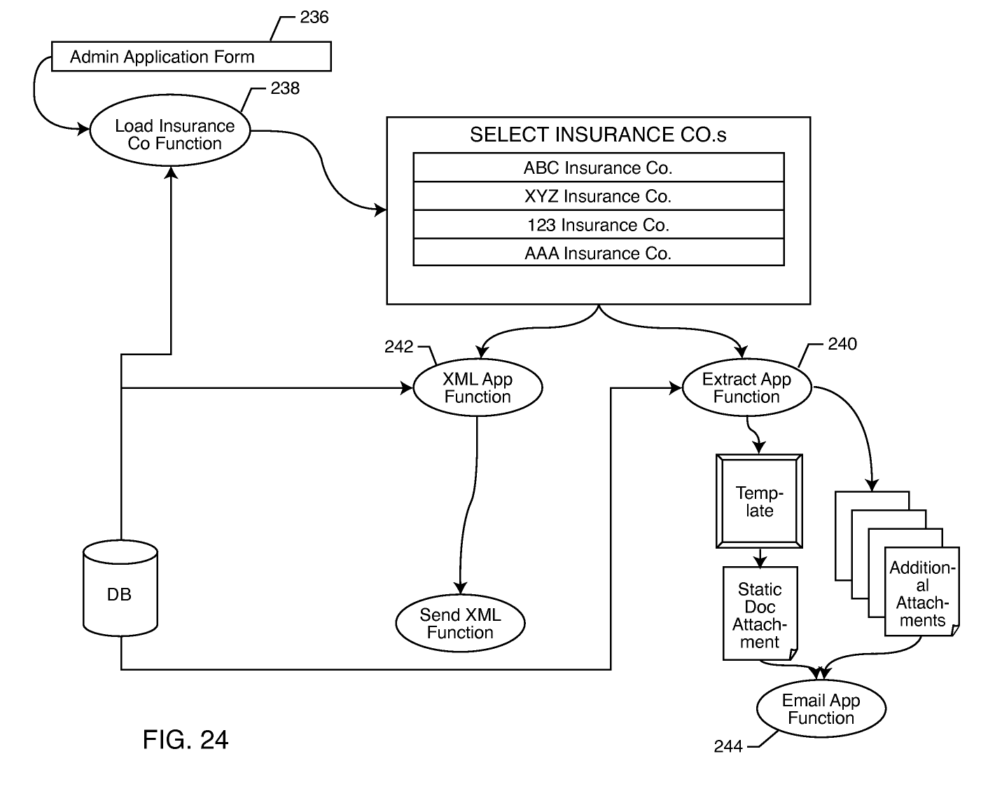

With reference to FIG. 24, the administrator application form (236) includes a load insurance company function (238) which extracts a listing of insurance companies from the database and enables the administrator to select an insurance company. That is, internal users or administrators are allowed to select insurance companies to which to submit a request for quotation. An extract application function (240) extracts all data required to prepare a request for quotation from the database and formats that data for use by the reports template or reports generator. Alternatively, an XML application function (242) extracts application data as XML, and uses HTTP, FTP or SOAP to transmit XML to insurance companies preferred transfer point. If utilizing the extract application function, the information is generated and compiled into a template which may be e-mailed (244) to the insurance company. The e-mail application function (244) creates emails to which are attached the application and any associated documents (including financials, officers, broker fees, etc.) and sends the e-mails to the appropriate e-mail addresses.

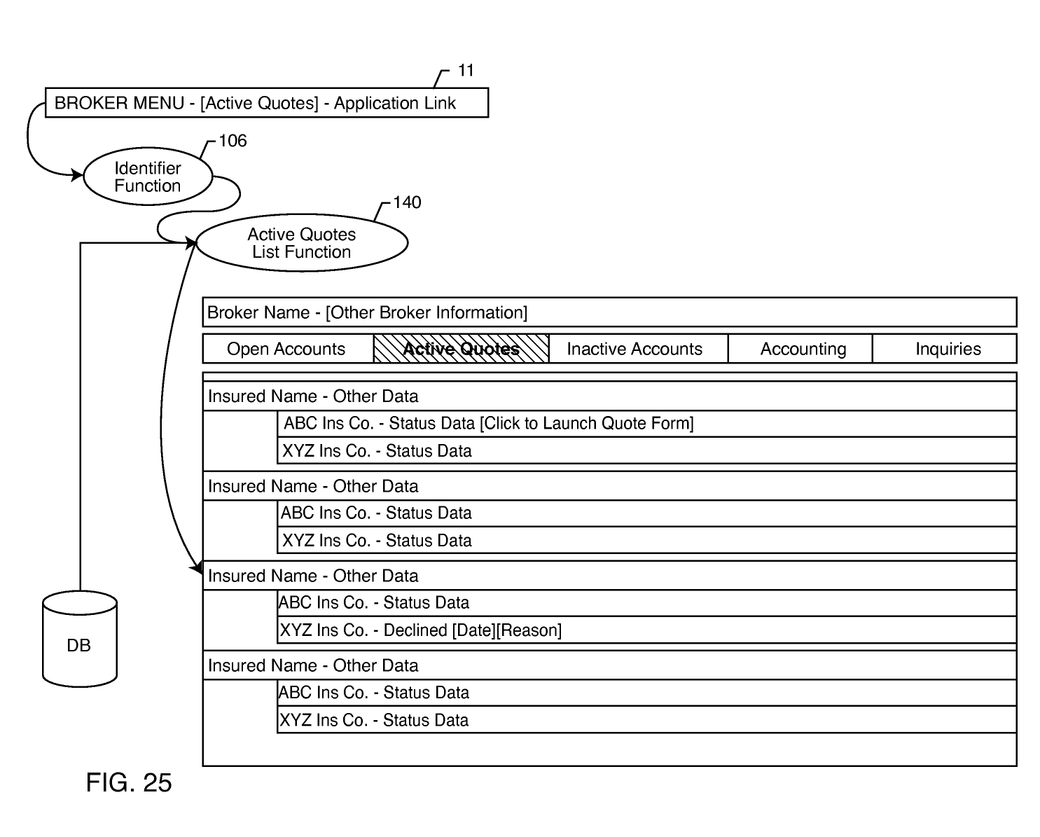

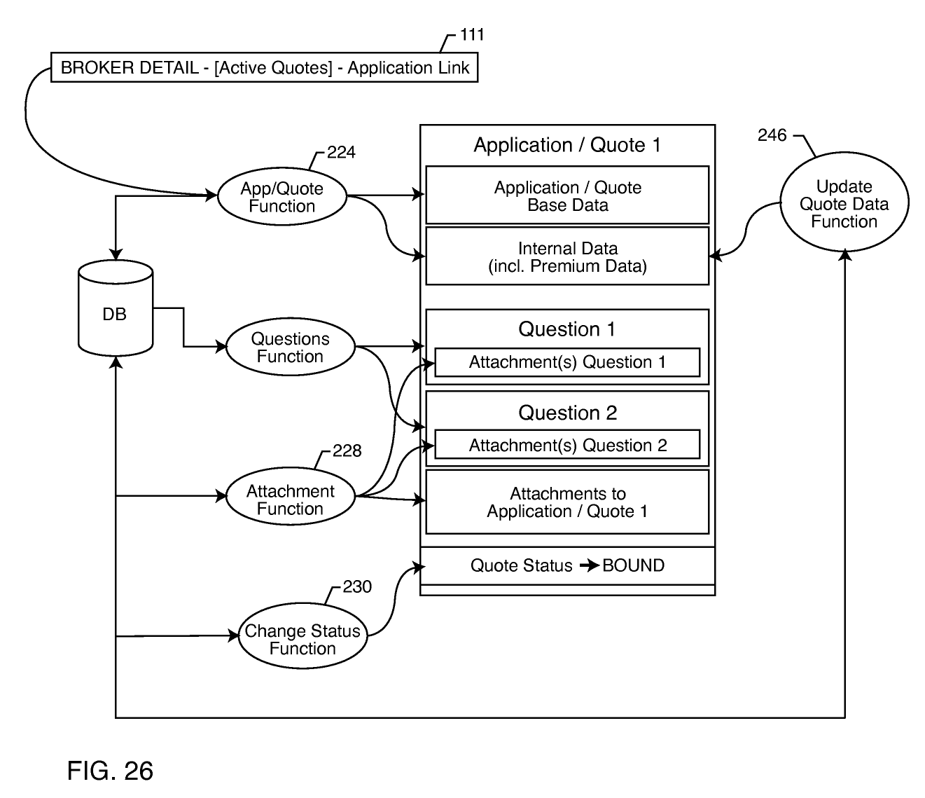

With reference now to FIG. 25, the active quote list function (140) extracts active quote summary data from the database, such as in a manner illustrated in FIG. 25. FIG. 26 illustrates steps similar to that shown in FIG. 23, in that application/quote function, questions function, attachment function, and change status function are used to update the quote data (246) and application by the internal user or administrator.

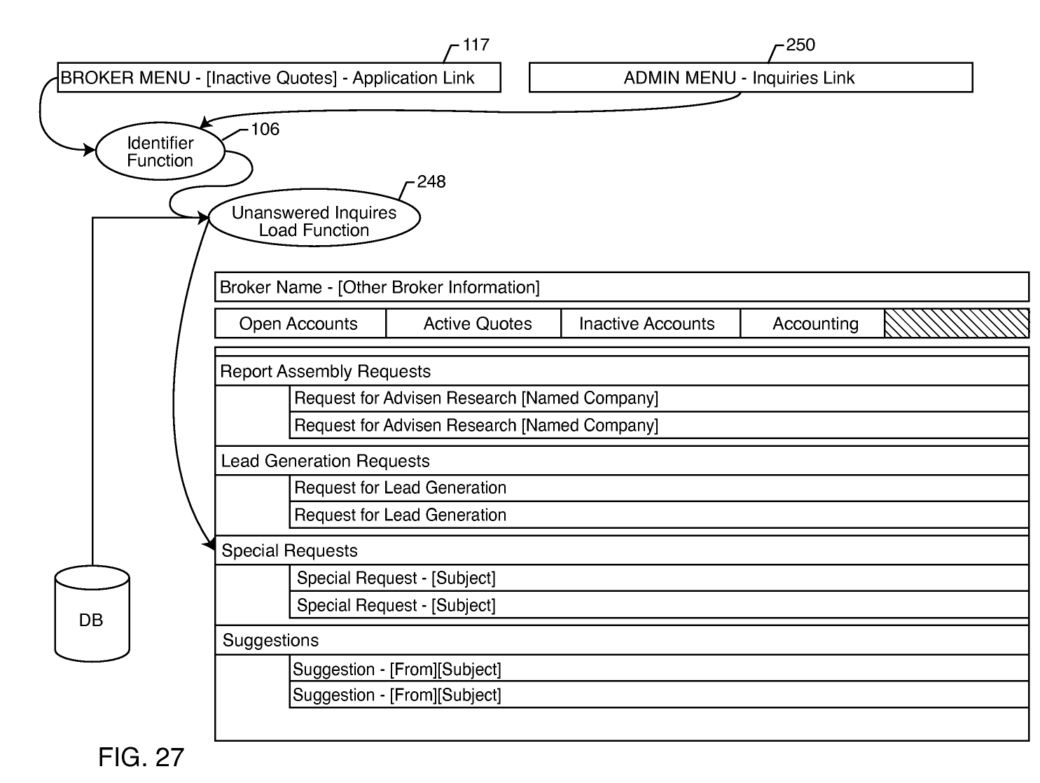

With reference to FIG. 27, when the inquiries tab (250) of the broker detail window (216) is selected, an unanswered inquiries function (248) extracts pending inquiries data for a specific internal user or a specific broker and formats this for presentation. This is typically presented in the inquiries grid form, which presents a listing of pending inquiries from the brokers assigned to that particular internal user. This can be filtered to present inquiries from a specific broker.

A response form is made available to present an interface to allow internal users to respond to broker inquiries, and to attach supporting electronic documents. The system looks at the broker I.D., broker name, broker user name, broker user e-mail, request type, request date, response requested by and request text from the database records identified. The respective labels, as read-text, is populated with this data. The response attachment function and form allows internal users to attach supporting documents to the response to an inquiry. The e-mail response function sends an inquiry response from an internal user to a broker, including attached supporting documents as attachments.

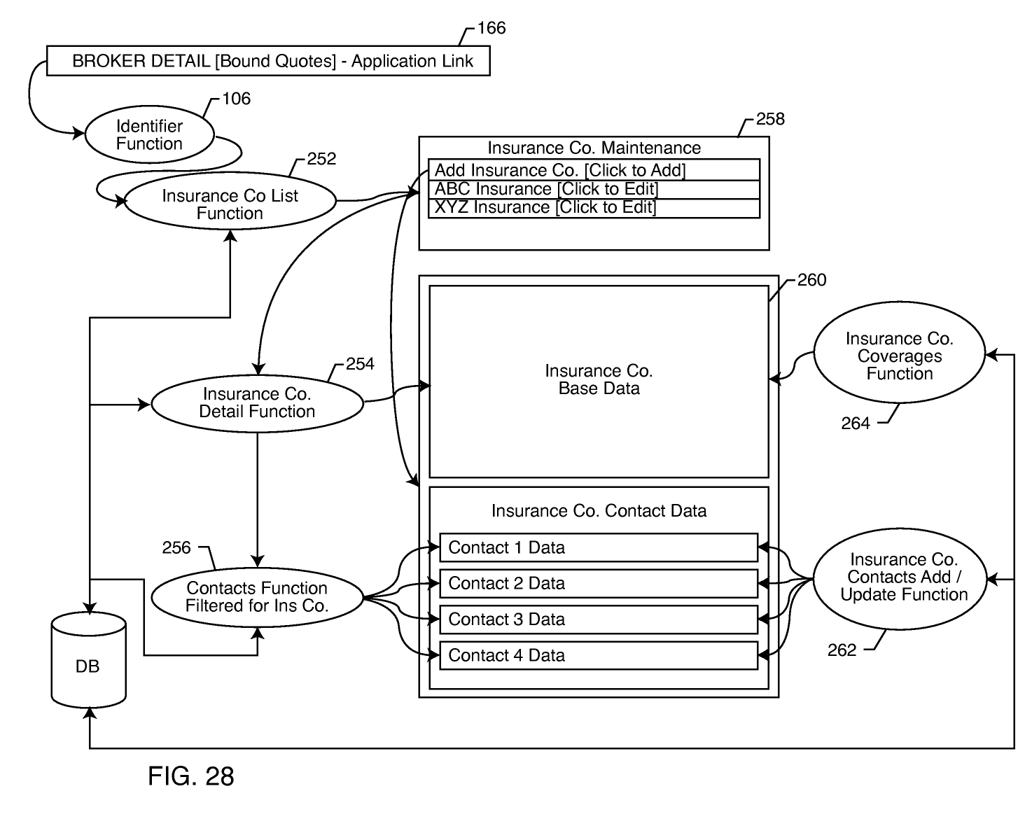

With reference now to FIG. 28, an insurance company list function (252) extracts lists of insurance companies from the database, and insurance company detail function (254) extracts individual insurance company information from the database. A contacts function filter (256) for insurance company extracts and contacts filtered by the insurance company from the database. An insurance company selector form (258) displays a list of insurance companies and a link to launch a form to add additional insurance companies. The insurance company base data form (260) presents an interface to allow internal users to add additional insurance companies data, and edit data from insurance companies already in the system. The mode selected may be add, edit, or delete. An insurance company contacts function (262) presents an interface to allow internal users to add, update, or delete contacts data for individuals associated with a particular insurance company. An insurance company coverages form (264) enables the user to associate available coverages with a specific insurance company.

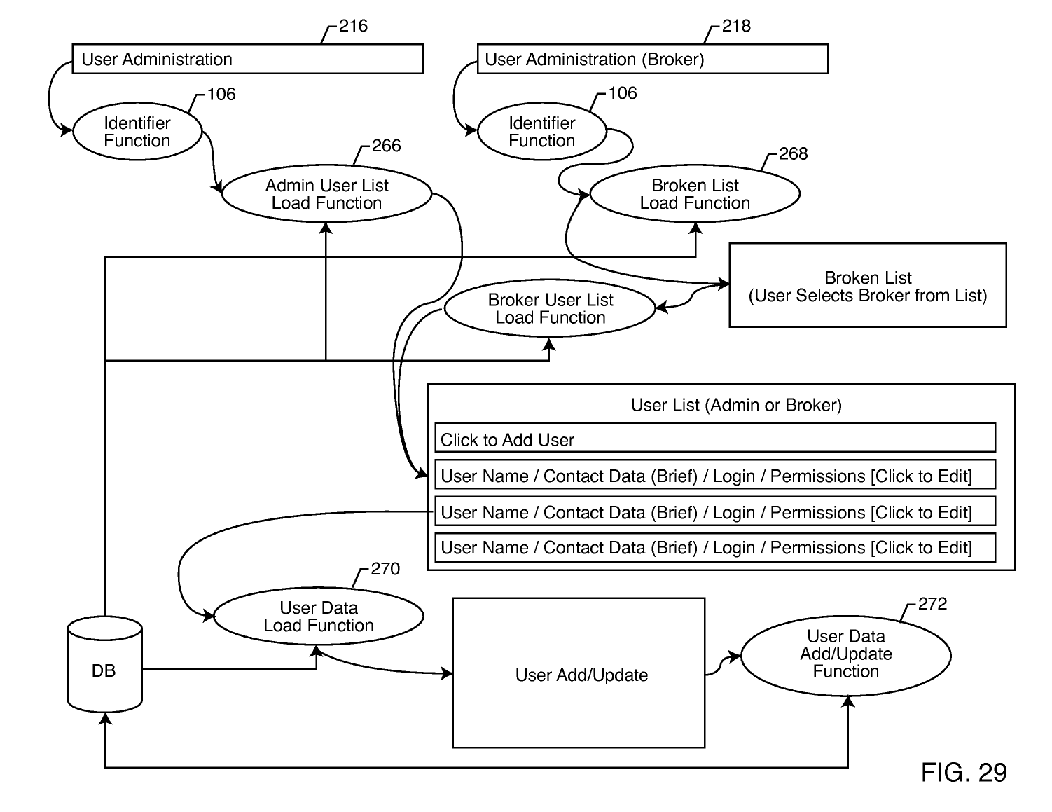

With reference to FIG. 29, a user administrator (216), or internal user (218), tab incorporates an administrator user list load function (266), which extracts lists of administrative users from the database. Similarly, a broker list load function (268) extracts a list of brokers from the database and creates a list. This may be filtered for a selective user. When a particular user name is selected from the user list, a user data load function (270) extracts data for the selected user from the database. A user data add/update function (272) adds or updates the selected user data to keep this data current.

A broker maintenance form allows the administrator user to associate brokers with a specific internal user. A broker maintenance grid allows the internal administrative user to manage the broker records. This may be to add a broker record, delete a broker record, or edit and updated broker record as the need dictates.

An application/quote status function determines the status of a particular application or quote. The function indicates whether the application is pending, submitted, if there are any unanswered questions, if the quote is expired, etc.

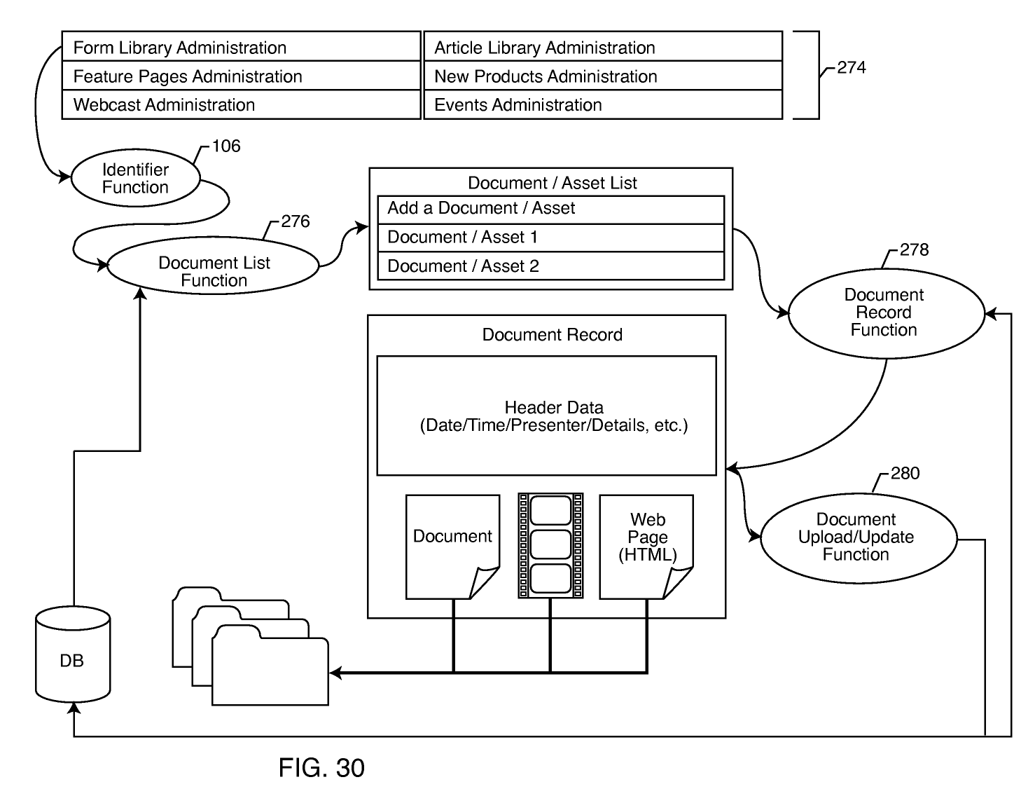

With reference now to FIG. 30, in various System Administrator tabs (274) a document list function (276) extracts a list of documents from the database by type, whether they be article, web cast, etc. A document record function (278) extracts individual document records, that is, to complete data for each record, from the database, and a document upload/update function (280) adds or updates the document record to the database and uploads the document to the document library for access by others.

As described herein, the system of the present invention automates and simplifies insurance transactions, particularly between brokers and insurance companies. This is done by maintaining databases of information on insured, insurance companies, and brokers. Brokers are able to view records for their insureds as well as for the insurance companies from which they will receive quotes. Information is populated into forms having a format which is transferable and readable by any of the parties involved. An internal user or administrator can manage from a top level the participation of various brokers and insurance companies, and provide additional benefits not currently available to each. Those skilled in the art will appreciate that there are other advantages presented by the present invention.

The system and software of the present invention is a two-sided product, designed to streamline the commercial insurance quotation process for the retail insurance broker, the intermediary and the insurance company, as well as provide the insurance company with comfort that their terms and conditions cannot be amended or changed in any way without their permission. Additionally, the ultimate insurance buyer will get to review more options for their insurance, which time constraints in the quotation process may have inhibited in the prior art. It is contemplated that the present invention will not only be a software product or software-based system, but rather an insurance community, where all participants in the insurance industry can ask questions, gather up to the minute information on various products, secure electronically fillable applications and corresponding policy forms from any participating insurance company.

The system of the present invention is preferably designed so as to provide “data pouring” capabilities from both ends of the commercial insurance transaction. From the insured's side of the process, they would enter their data into an on-line, electronically fillable application. Once that data is entered into the fillable application, it is routed directly to the system's agency management software system, as well as to the client's agency management software system and would be captured, without either party having to perform any additional data entry work.

From the insurance company's side of the process, the underwriter, such as at ABC Insurance Company, would provide a quotation letter. In that quotation letter, the various bits of data would be coded to populate the various text boxes. The system, or employees of the system, would validate the accuracy of the terms and conditions of the quotation. The quotation data would then be transferred to the client's final presentation format template, which is contained within the system application. When this process has occurred, an e-mail is preferably sent to the appropriate party at the client's office notifying them that their quote is ready and to click on the link to download the quotes and supporting documentation (such as endorsements, applications, sales information, etc.). Although several embodiments have been described in detail for purposes of illustration, various modifications may be made without departing from the scope and spirit of the invention. Accordingly, the invention is not to be limited, except as by the appended claims.

What is claimed is:

1. A process for automating and simplifying transactions between brokers and insurance companies, comprising the steps of:
maintaining an electronic database of information on insureds, insurance companies and brokers;
populating a plurality of electronic forms with information on one of said insureds from the electronic database;
electronically transferring said plurality of electronic forms simultaneously to one or more of the insurance companies as requests for quote;
receiving electronic quotes from said one or more of the insurance companies in response to the requests for quote; and
electronically forwarding the quotes to the insured.

2. The process of claim 1, further comprising the steps of establishing a first relationship between information on one of the brokers with information on one or more of the insureds, and establishing a second relationship between information on said one of the brokers with information on one or more of the insurance companies.

3. The process of claim 1, wherein said plurality of electronic forms are electronically readable by one or more of the insurance companies.

4. The process of claim 1, further comprising the step of electronically reviewing information on insureds including open accounts, inactive accounts, and available quotes.

5. The process of claim 4, wherein the information on insureds includes the identity of the insured, current coverage, submitted requests, requested coverage levels, dates of requests, responses to questions, and status of requests.

6. The process of claim 4, wherein the available quotes include offers of coverage, denials of coverage, and bound policies with payment history.

7. The process of claim 1, wherein the electronically transferring step involves the step of generating said electronic forms for printing, storing in the electronic database or e-mailing.

8. The process of claim 4, wherein the inactive accounts include status of previous requests for quote.

9. The process of claim 8, further comprising the step of automatically resubmitting previous requests for quote.

10. A process for automating and simplifying transactions between brokers and insurance companies, comprising the steps of:
maintaining an electronic database of information on insureds, insurance companies and brokers;
establishing a first relationship between information on one of the brokers with information on one or more of the insureds, and establishing a second relationship between information on said one of the brokers with information on one or more of the insurance companies;
populating a plurality of electronic forms with information on one of said insureds from the electronic database;
generating said electronic forms for printing, storing in the electronic database or e-mailing;
electronically transferring said plurality of electronic forms simultaneously to one or more of the insurance companies as requests for quote;
receiving electronic quotes from said one or more of the insurance companies in response to the requests for quote; and
electronically forwarding the quotes to the insured.

11. The process of claim 10, wherein said plurality of forms are electronically readable by one or more of the insurance companies.

12. The process of claim 10, further comprising the step of electronically reviewing information on insureds including open accounts, inactive accounts, and available quotes.

13. The process of claim 12, wherein the information on insureds includes the identity of the insured, current coverage, submitted requests, requested coverage levels, dates of requests, responses to questions, and status of requests; wherein the available quotes include offers of coverage, denials of coverage, and bound policies with payment history; and wherein the inactive accounts include status of previous requests for quote.

14. The process of claim 10, wherein the electronically transferring step involves the step of generating said electronic forms for printing, storing in the electronic database or e-mailing.

15. The process of claim 12, further comprising the step of automatically resubmitting previous requests for quote.

16. A process for automating and simplifying transactions between brokers and insurance companies, comprising the steps of:
maintaining an electronic database of information on insureds, insurance companies and brokers;
electronically reviewing information on insureds including open accounts, inactive accounts, and available quotes;
populating a plurality of electronic forms with information on one of said insureds from the electronic database, wherein said plurality of forms are electronically readable by one or more of the insurance companies;
electronically transferring said plurality of electronic forms simultaneously to one or more of the insurance companies as requests for quote;
receiving electronic quotes from said one or more of the insurance companies in response to the requests for quote; and
electronically forwarding the quotes to the insureds.

17. The process of claim 16, further comprising the steps of establishing a first relationship between information on one of the brokers with information on one or more of the insureds, and establishing a second relationship between information on said one of the brokers with information on one or more of the insurance companies.

18. The process of claim 16, wherein the information on insureds includes the identity of the insured, current coverage, submitted requests, requested coverage levels, dates of requests, responses to questions, and status of requests; wherein the available quotes include offers of coverage, denials of coverage, and bound policies with payment history; and wherein the inactive accounts include status of previous requests for quote; and
further comprising the step of automatically resubmitting previous requests for quote.

19. The process of claim 16, wherein the electronically transferring step involves the step of generating said electronic forms for printing, storing in the electronic database or e-mailing.
